(19) United States
(12) Patent Application Publication
(10) Pub. No.: US 2014/0044858 A1
(43) Pub. Date: Feb. 13, 2014

(54) STABLE SOLID FORM AGAVE SWEETENERS AND METHODS FOR MANUFACTURE THEREOF

(71) Applicant: José Quevedo, San Martin Hidalgo (MX)

(72) Inventor: José Quevedo, San Martin Hidalgo (MX)

(73) Assignee: HACIENDA SAN JOSÉ DE MIRAVALLE, San Martin Hidalgo, JA (MX)

(21) Appl. No.: 14/114,181

(22) PCT Filed: Apr. 25, 2012
(86) PCT No.: PCT/US12/35066

§ 371 Date: Oct. 25, 2013

Related U.S. Application Data
(60) Provisional application No. 61/478,905, filed on Apr. 25, 2011.

(51) Int. Cl. A23L 1/236

(52) U.S. Cl. CPC A23L 1/236
USPC 426/655; 426/524

(57) ABSTRACT

The invention relates to dry solid crystalline, powder, granular or amorphous forms of agave sweeteners that retain beneficial nutrients present in agave syrup and remain stable for extended periods of time. Methods for manufacture of the dry sweeteners from agave nectar are provided that employ a process comprising lyophilization. Methods for producing agave sweeteners in crystalline, powder, granular or amorphous form are provided. In addition to extended stability, manufacture using lyophilization techniques retain beneficial characteristics of the agave nectar that are lost when it is dried by other techniques.

### CROSS-REFERENCE TO RELATED APPLICATIONS

This application is a U.S. national stage application under 35 USC §371 of International Application number PCT/US2012/035066 filed Apr. 25, 2012, which claims priority to U.S. Provisional Patent Application Ser. No. 61/478,905 filed Apr. 25, 2011, the contents of which are incorporated herein in their entirety by reference.

### TECHNICAL FIELD OF THE INVENTION

The present invention relates to sweeteners, and in particular to dry forms of sweeteners obtained from nectar of the agave plant. Specifically, the invention relates to novel methods for manufacture of dry forms of agave sweeteners.

### BACKGROUND OF THE INVENTION

Sugar is a term for a class of edible crystalline carbohydrates, mainly sucrose, lactose, and fructose (IUPAC. Compendium of Chemical Terminology, 2nd ed. (the “Gold Book”). Compiled by A. D. McNaught and A. Wilkinson. Blackwell Scientific Publications, Oxford (1997)). Sugar is further characterized by a sweet flavor. In food, sugar almost exclusively refers to sucrose, which primarily comes from sugar cane and sugar beet. Other sugars are used in industrial food preparation, but are usually known by more specific names—glucose, fructose or fruit sugar, high fructose corn syrup, and the like.

Ancients primarily used honey for sweetening until methods for turning sugarcane juice into granulated crystals that were easier to store and to transport were discovered in India around 5^{th} century C.E. With the advance of technology methods to extract sugar from other sources, such as beets, potatoes, chicory, etc. were developed.

The term sugar usually refers to sucrose, which is also called “table sugar” or “saccharose.” Sucrose is a white crystalline disaccharide. It is primarily obtained from sugar cane or sugar beet. Sucrose is the most popular of the various sugars for flavoring, as well as properties (such as feel, preservation, and texture) of beverages and food. The chemical term “sugar” also can be used to refer to water-soluble crystalline carbohydrates with varying degrees of sweetness, such as monosaccharides (e.g., glucose, fructose, galactose), disaccharides (e.g., sucrose, lactose, maltose), trisaccharides, and oligosaccharides, in contrast to complex carbohydrates such as polysaccharides. Corn syrup, dextrose, crystalline fructose, and maltose, for example, are used in manufacturing and preparing food as sweeteners.

During the last century, the Western diet became increasingly dominated by refined sweeteners such as granulated sugar and corn syrup. The problem with these substances is their high glycemic index and glycemic load. The glycemic index (“GI”) is a measure of the effects of carbohydrates on blood sugar levels. Carbohydrates that break down quickly during digestion and release glucose rapidly into the bloodstream have a high GI; carbohydrates that break down more slowly, releasing glucose more gradually into the bloodstream, have a low GI. Foods that raise blood sugar quickly trigger the release of the hormone insulin. Excessive releases of insulin and, more specifically, chronically high blood sugar and insulin levels are linked to Metabolic Syndrome (also called Syndrome X), which is a complex of health disorders. Associated ailments include insulin resistance and type II diabetes, abdominal weight gain and obesity, problems with blood lipids (raised triglycerides and cholesterol) and high blood pressure. Therefore, the high glycemic index of refined sweeteners like common granulated sugar makes it highly undesirable for people suffering from such diseases to consume these sugars or products manufactured with common sugars.

In order to address this need, artificial high intensity sweeteners (having 180 to 300 times the sweetness of an equivalent dose of sucrose) were developed such as Canderel®, Splenda®, aspartame, saccharin, acesulfame potassium, sucralose, and the like. High Intensity Sweeteners (HIS) also include natural sweeteners such as Lo Han guo, Neohesperidin dihydrochalcone (NHDC), thaumatin, stevia, and taglatose.

However, there are several drawbacks to using artificial sweeteners. First, they are generally chemical compounds which can have adverse effects on a consumer's health. For example, aspartame can be dangerous for phenylketonurics. Second, several standard culinary methods are not adaptable to artificial sweeteners. Natural sugars are a virtually indispensable aid to caramelization or browning. Baked food products made with an artificial sweetener may have a reasonably good flavor, but have a pale and unappetizing appearance. In yeast dough, sugars are needed to feed the yeast which leavens the bread. While there are some natural sugars in wheat flour, they are not in sufficient quantity or in simple enough form to make them quickly usable to the yeast. Sugars also act as a humectant to help baked goods retain the moisture they need to remain soft and fresh. Additionally, sugars inhibit microbial action and extend shelf life in foods. Removing sugar from many sweets can also result in a compromised texture; for example, ice cream made with an artificial sweetener can produce a frozen product that is full of ice crystals and unpleasantly hard, unless additional softening agents are introduced. Stevia is a sweetener extracted from its homonymous plant, the species Stevia rebaudiana, commonly known as sweetleaf, sweet leaf, sugarleaf, or simply stevia, is widely grown for its sweet leaves. As a sweetener and sugar substitute, stevia's taste has a longer duration than that of sugar, although some of its extracts may have a bitter aftertaste at high concentrations. Stevia offers little or no nutritional value, and its availability around the world has been restricted due to health concerns.

Agave syrup or agave nectar is a superb natural product that is useful as an efficient sweetener with health benefits. Agave nectar is at least 120% to 200% sweeter compared to table sugar. Its sweetness comes primarily from a complex form of fructose called inulin. Agave contains natural fructose as opposed high fructose corn syrup often used as a sweetener. Agave nectar's low glycemic index makes it suitable for some individuals on low-carbohydrate or slow-carbohydrate diets (the Atkins Diet, the South Beach Diet) and for a variety of weight loss or weight management programs. Granulated sugar has an average glycemic index in the high 60's, while agave syrup generally has GI index between 20 and 30 and glycemic load of about 1.4. Foods with a glycemic index lower than 55 are considered low glycemic foods. Foods lower on the scale are less likely to trigger the body's mechanisms for insulin storage.

Though agave nectar is more calorie-dense than brown or white sugar, it is about 40% sweeter, so lesser amounts of agave can be used. Artificial sweeteners provide sweetness, but few of the functional properties of real sugars. Agave provides the same variety of functions (including browning, moisture retention, softening and food preservation) as processed sugars. Agave nectar is a real sugar, as opposed to an artificial or non-nutritive sweetener. It has properties similar to many sugars with one important exception: its glycemic index is significantly lower. This makes it a healthier alternative to many processed and natural sweeteners. Thus agave sweeteners are more beneficial than most processed and natural sweeteners such as, white granulated sugar, brown sugar, demerara or turbinado sugar, maple sugar crystals, dehydrated cane juice, and date sugar.

Agave nectar is most easily substituted for liquid sugars, since it is already in liquid form and the difference in moisture will usually be negligible. However, liquid agave syrup is not the most convenient form of sweetener as it is difficult to store or transport in bulk quantities, or to add to food products in amounts standardized for dry sweeteners. Yet, due to the high fructose content of agave nectar and the high water solubility of fructose, it has been difficult to manufacture stable, dry solid forms of the agave sweetener.

Attempts to manufacture dry powders forms of agave nectar have been attempted but failed to provide stable, solid forms such as crystals or powders. These methods of production typically used liquid-phase drying or spray drying techniques. Spray Drying is a method of producing a dry powder from a liquid or slurry by rapidly drying with a hot gas. While, relatively inexpensive, spray drying has significant drawbacks. Spray drying exposes biologicals to shear stress during the atomization step, which could destabilize labile biopharmaceutical compounds such as proteins. Complex biological molecules are difficult to spray dry because they are sensitive to high shear stress.

Further, the spray dried product rapidly converts to a compound that transforms rapidly to a very gooey substance, very similar to a viscous bee honey. This is probably due to the nature of the sugars in agave syrup. Unfortunately, the gooey substance clogs the spray drying equipment to a halt and it has to be washed with hot pressurized water in order to restart the process. The product obtained by spray drying or liquid drying process leaves a sand-like after taste due to need for addition of drying compound which expands by to about twice the volume due to water absorption.

Thus, there is a need for novel and efficient methods for manufacture of stable dry powder or crystal forms of agave sweetener that have reasonably long shelf life and do not destroy the beneficial ingredients contained in the agave nectar during the process of manufacture.

### SUMMARY OF THE INVENTION

The inventors have made the surprising observation that agave syrup, when crystallized by lyophilization, result in a solid agave sweetener that is stability under standard storage conditions. Thus the present invention also provides a novel method for production of agave sweetener in dry form by a process comprising lyophilization. Lyophilization is known to preserve perishable materials and increase stability of biological materials for convenient storage and transport.

Therefore, the methods of the present invention produces agave sweetener in solid form, while preserving its perishable ingredients, enzymes, minerals and overall beneficial characteristics.

The invention relates to an agave sweetener in dry form, wherein the dry agave sweetener retains essentially all of the perishable biological material contained in the agave nectar. In some embodiments, the dry agave sweetener is prepared from agave nectar by a process comprising lyophilization.

In some embodiments, the sweetener is crystalline, amorphous, powder, granular or a mixture thereof. In some aspects, the sweetener has an average particle size of 0.1 μm to 100 μm.

In some aspects, the sweetener further comprises a hygroscopic compound. In some embodiments, the hygroscopic compound is selected from maltodextrin, dextrose, glycolic acid, dried corn syrup, Stevia®, sugar from sugarcane, sweet potato or beet, or a mixture thereof.

In some aspects, the sweetener has equivalent sweetness about 120-200% compared to that of table sugar.

In some aspects, the sweetener is never heated above 50° C. at any time of production from harvest of raw agave.

The invention further provides a method for producing an agave sweetener in dry form, the method comprising: a) introducing an agave nectar liquid in a lyophilization device; reducing the temperature to below 0° C. and pressure to below atmospheric in the device; and c) allowing a time period sufficient for sublimation of water contained in the agave nectar until one or more crystals of dry agave sweetener is formed.

In some aspects the method further comprises: inoculating the agave nectar liquid with a hygroscopic compound which comprise solids that may serve as base from where other crystals are formed. In some embodiments, the hygroscopic compound is selected from maltodextrin, dextrose, glycolic acid, dried corn syrup, Stevia®, sugar from sugarcane, sweet potato or beet, or a mixture thereof.

In some embodiments of the method, the temperature is reduced to −50° C. and the pressure is reduced to 10 microns.

In some aspects the agave plant is selected from Agave tequilana, Agave salmeana, Agave Americana, Agave maguey and Agave mapisaga.

The invention further provides a method for replacing a sweetener in the diet of an individual with a stable, dry form of agave sweetener, wherein the individual is suffering from or susceptible to metabolic syndrome, insulin resistance, type II diabetes, abdominal weight gain and obesity, abnormal blood lipid profile (raised triglycerides and cholesterol) and high blood pressure.

These and other aspects will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The following drawings form part of the present specification and are included to further demonstrate certain aspects of the present disclosure, the inventions of which can be better understood by reference to one or more of these drawings in combination with the detailed description of specific embodiments presented herein.

FIG. 1 shows a schematic for the preparation of agave nectar from raw agave according to the steps disclosed in Table 1.

### DETAILED DESCRIPTION OF THE INVENTION

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

Unless otherwise defined, all technical and scientific terms used herein have the same meaning as commonly understood by one of ordinary skill in the art to which this invention pertains. In the case of conflict, the present document, including definitions will control. The following references provide one of skill with a general definition of many of the terms used in this invention: Singleton et al., Dictionary of Microbiology and Molecular Biology (2nd Ed. 1993); The Cambridge Dictionary of Science and Technology (Walker ed., Cambridge University Press. 1990); The Glossary of Genetics, 5th ed., R. Rieger et al. (eds.), Springer Verlag (1991); and Hale & Margham, The Harper Collins Dictionary of Biology (1991).

The following definitions are to be understood throughout this description and in the appended claims: A “foodstuff” is a substance that can be used or prepared for use as a food. A “carbohydrate” as defined in Organic chemistry, Second Edition by William H. Brown and Christopher S. Foote (Saunders, 1998) is a polyhydroxyaldehyde, polyhydroxyketone, or substance that gives these compounds upon hydrolysis. A “monosaccharide” is a carbohydrate that cannot be hydrolyzed to a simpler carbohydrate. A “disaccharide” is a carbohydrate containing two monosaccharide units joined by a glycoside bond. A “trisaccharide” is a carbohydrate containing three monosaccharide units joined by a glycoside bond. A “polysaccharide” as defined in Webster's Ninth New Collegiate Dictionary (Merriam-Webster, 1988), is a carbohydrate that can be decomposed by hydrolysis into two or more molecules of monosaccharides (thus, this definition subsumes the definitions of disaccharide and trisaccharide). An “extract” refers to food additives. “Intense sweeteners” is a term well-known in the art which refers to compounds that are significantly sweeter than sucrose. “Natural sweeteners” refers to sucrose, fructose, dextrose, maltose, and the like.

By the term “crystal” or “crystalline” it is understood that the material possesses properties of crystallized sugar. Thus agave crystals are “breakable” such that when chewed it sounds like breaking glass. However, it does not imply that each grain of a crystal is necessarily transparent as it can have a cloudy or a tinted appearance (yellowish or brownish crystals). According to the invention, the term crystal refers to its chemical composition and not only to the transparent or semi-transparent solid crystal forms the size of a grain of salt. Thus, an agave solid sweetener in a powder form is a crystal according to the invention.

The genus Agave is placed in the subfamily Agavoideae of the family Asparagaceae. Agave tequilana, commonly called agave azul, blue agave, tequila agave, mezcal or maguey is an agave plant that is an important economic product of Jalisco, Mexico, due to its role as the base ingredient of tequila, a popular distilled spirit. Although the nectar or syrup is most often produced from blue agave, at least six other varieties of agave are in current use, such as Agave salmeana, Agave Americana, Agave maguey and Agave mapisaga. The high production of sugars—mostly in the form of fructose—in the core of this plant is the most important characteristic of the plant making it suitable for the preparation of alcoholic beverages. Agave has been known for centuries in central Mexico, providing tools, fiber for ropes and clothing, and more importantly, the sweet juice to drink as is or to produce tequila. Agave nectar also has been shown to have anti-bacterial properties against pyrogenic bacteria (Staphylococcus aureus) and also enteric bacteria.

Agave “nectar” is not made from the sap of the yucca or agave plant but from the starch of the giant pineapple-like, root bulb. The principal constituent of the agave root is starch, similar to the starch in corn or rice, and a complex carbohydrate called inulin, which is made up of chains of fructose molecules. Technically an indigestible fiber, inulin, which does not taste sweet, comprises about half of the carbohydrate content of agave.

To produce the nectar, when the agave has grown to 7-10 years old, the leaves of the plant are cut off, revealing the core of the plant (called the “piña”). When harvested, the piña resembles a large pineapple and can weigh in at 50 to 150 pounds. To make the agave nectar, sap is extracted from the piña, filtered, and heated at a low temperature, which breaks down the carbohydrates into sugars. Lighter and darker varieties of agave nectar are made from the same plants. Because of the low temperatures used in processing many varieties (under 118° F.) raw foods enthusiasts generally regard agave nectar as a raw food.

The process by which agave glucose and inulin are converted into “nectar” is similar to the process by which corn starch is converted into HFCS. The agave starch is subject to an enzymatic and chemical process that converts the starch into a fructose-rich syrup

Native Mexican people make a sort of sweetener out of the agave plant. It's called miel de agave, and it's made by boiling the agave sap for a couple of hours. This is similar to maple syrup. Agave nectar also is made from the starch of the giant pineapple-like, root bulb. The principal constituent of the agave root is starch, similar to the starch in corn or rice, and a complex carbohydrate called inulin, which is made up of chains of fructose molecules. This is hydrolyzed to monosaccharides (fructose) by enzymatic treatment.

The agave nectar is characterized by high content of natural fructose or inulin (about 90% of sugars). The solubility of fructose at 25° C. is 4 g/g in H₂O. This represents the highest solubility of most, if not all, sugars and sugar alcohols. It is for this reason that fructose is so difficult to crystallize from aqueous solution. (Hanover L M and White J S. Amer. J. of Clin. Nutr. 58(suppl.):724S-732S (1993). Methods for crystallization of fructose from organic and aqueous solutions have been developed and these involve at least some heating steps. (U.S. Pat. Nos. 3,513,023; 3,607,392; 4,895,601; 3,883,365).

Inulin is a term applied to a heterogeneous blend of fructose polymers found widely distributed in nature as plant storage carbohydrates. Oligofructose is a subgroup of inulin, consisting of polymers with a degree of polymerization (DP)≦10. Inulin and oligofructose are not digested in the upper gastrointestinal tract; therefore, they have a reduced caloric value. They stimulate the growth of intestinal bifidobacteria. They do not lead to a rise in serum glucose or stimulate insulin secretion. Its flavor ranges from bland to subtly sweet (approx. 10% sweetness of sugar/sucrose). It can be used to replace sugar, fat, and flour. This is advantageous because inulin contains 25-35% of the food energy of carbohydrates (starch, sugar). In addition to being a versatile ingredient, inulin has many health benefits. Inulin increases calcium absorption (Abrams S, et al. (2005) “A combination of prebiotic short- and long-chain inulin-type fructans enhances calcium absorption and bone mineralization in young adolescents” Am J Clin Nutr 82 (2): 471-476) and possibly magnesium absorption, (Coudray C, et al. (2003). “Effects of dietary fibers on magnesium absorption in animals and humans”. J Nutr 133 (1): 1-4) while promoting the growth of intestinal bacteria. In terms of nutrition, it is considered a form of soluble fiber and is sometimes categorized as a prebiotic. Due to the body's limited ability to process fructans, inulin has minimal increasing impact on blood sugar, and—unlike fructose—is not insulemic and does not raise triglycerides, making it suitable for diabetics and potentially helpful in managing blood sugar-related illnesses. (Niness K R, “Inulin and Oligofructose: What Are They?” J. Nutr. Jul. 1, 1999 vol. 129 no. 7 1402s-1406s).

A product according to an embodiment of this invention is a stable, crystallized form of agave syrup. It is consistent with characteristics commonly associated to those of sugar, such as granular physical form, white or light brown color, sweet to the taste and easy to apply on numerous foods and beverages as it is often described in many recipes to be measured in teaspoons or tablespoons or grams (weight).

The physical characteristics of the crystallized agave sweetener are not very different from sugar, and the similarities are very desirable. It is unique in that it does not occur in nature without human intervention, and efforts to produce it in a stable form with shelf life by other methods have failed so far. The crystallized agave syrup is a very particular product that shares similarities with other commonly referred to as “sugars,” but radically differs from those in the origins of the raw material from which it is produced (agave) and because of the properties of the component chemicals (sugars such as fructose) is very difficult to convert to stable solid form. Unlike, for example, honey which after a couple of months starts to solidify on its own.

A “stable” solid form of the agave sweetener according to the invention is characterized by a shelf life of at least 3 months, six months, 1 year, 2 years, 5 years or longer. Shelf life is measured as the time period for which the dry agave sweetener retains it crystal or powder structure without absorbing undesirable amounts of sugar when stored in a closed container. Inclusion of a package of dessicant or drying agent may further increase the shelf life of the solid form agave sweetener.

Lyophilization, or freeze drying, is the processing method used according to this invention for removing moisture from agave crystals. It has been surprisingly found that forming dry agave crystals or powder from the nectar by lyophilization can increase the stability, temperature tolerance, and shelf life of the products. Lyophilization gives the opportunity to avoid denaturation caused by heating the product, by maintaining it frozen throughout drying. This is the most obvious advantage over liquid-phase drying or spray drying as attempted in prior methods.

Equally important is that in liquid-phase drying there is an undesirable shrinkage and concentration of active constituents that causes damage as well as a movement of these constituents to the surface of evaporation, where they form a dense, impermeable skin that inhibits drying, and later, rehydration. Such effects can be avoided by spray drying, but this requires brief exposure to damaging temperatures that can be as high as 100° C.

Further advantages of lyophilization for products are that the wet material can be accurately dispensed and can be sterile filtered just before filling into final containers so that particulate and bacterial contamination is reduced. Thus, the principle advantages of lyophilization as a drying process as implemented herein are: (a) minimum damage and loss of activity in delicate heat-liable materials; (b) speed and completeness of rehydration; (c) possibility of accurate, clean dosing into final product containers; and (d) porous, friable structure.

In contrast, previous attempts to make stable crystals of agave syrup employed spray drying which is a process whereby a liquid formulation is converted into a dry powder in a single step. The process is typically performed by first atomizing the solution into fine droplets that are then dried quickly in a large chamber by using a heated gas. However, the high temperature used in the process can adversely affect the stability of beneficial biological materials contained in the liquid formulation.

The lyophilization process presents the most benefits regarding the final product, as it dehydrates the syrup without altering chemically the contents of the syrup like other processes. The most common way to dehydrate a product is by raising the temperature to force water to evaporate and remove it, in vapor form, from the container in which the process is being held. That exposure to high temperature, unfortunately, changes the structure of enzymes, sugars, and other beneficial components of the syrup by denaturing them.

In one aspect, a hygroscopic compound is added to the agave nectar prior to neutralization, in order to form the initial crystals around which the agave nectar crystallizes and to retain moisture in the final lyophilized product. Typically the hygroscopic compound is a carbohydrate carrier selected from the group consisting of maltodextrin, dextrose, and combinations thereof, or any other solid that may serve as a base from where other crystals are formed. The hygroscopic compound prevents too much moisture being absorbed by the already dried crystallized agave sweetener solids. Hygroscopic compounds may absorb humidity resulting in “stone-like” formation.

In some aspects the hygroscopic additive comprises maltodextrin, dextrose or a combination of dextrose and maltodextrin, such as an agglomerated dextrose consisting of dextrose monohydrate and maltodextrin, sold as Unidex® (Corn Products U.S.). However, any sugar in solid form, such as solidified corn syrup, Stevia®, honey, caramel, glycolic acid, etc., can be used as the hygroscopic compound. Because of their affinity for atmospheric moisture, hygroscopic materials may be added to foods or other materials for the express purpose of maintaining moisture content, such substances are known as “humectants.”

The amount of the hygroscopic compound used in the agave sweetener composition can be any suitable amount. Typically, the amount of the hygroscopic compound is about 1 wt. % to about 40 wt. %, e.g., about 5 wt. % to about 30 wt. %, or about 10 wt. % to about 20 wt. %, based on the total weight of the composition.

In one embodiment, the hygroscopic compound is maltodextrin. Maltodextrin is a creamy white hygroscopic powder, moderately sweet in taste. It is produced by partial hydrolysis of starch by a typical total enzyme process using a bacterial alpha-amylase followed by refining and spray-drying to a moisture level of 3% to 5%. Maltodextrin is a mixture of glucose, maltose, oligosaccharides and polysaccharides.

Chemical composition of the agave crystals comprise, but are not limited to: the percentage of inulin may be 25 to 30%, but may be varied up to 35, 40, 45, or 50% by incorporating a higher content of it into the original syrup that is to be crystallized for the purpose of increasing the benefits that inulin is known for. Saccharose may also be at around 25 to 30%, and it may vary depending on the hygroscopic compound chosen. Glucose can be commonly in the 2-5% range, and may vary depending on the hygroscopic compound and inulin content. Fructose is at around 40%, and also may vary due to the same reasons. Agave nectar has a pH of around 4 to 5.

In one aspect the invention relates to agave sweeteners in crystal form. The size of the crystals can be regulated by slowing down the time taken to form crystals (resulting in larger crystals). (Childs, S. Chemistry of Maple Syrup. Cornell Maple Bull. 202 (2007). In some aspects, the crystalline sweetener is milled to smaller crystals or a dry powder form, which is more readily soluble.

The crystallized form of agave syrup (agave honey) is very similar to regular sugar in form, color and uses, is obtained from a plant of the agave family (preferably the blue agave plant variety) by desiccation and/or dehydration (including but not limited to variations in pressure, temperature, luminescence, vibration, all of which can be applied through different methods or procedures).

It can be processed to have varying sweetness, color, odor, humidity, acidity and taste. It can be worked to grains of different sizes and shapes or even to powder.

Not occurring by itself in nature or by any natural process without the intervention of industrial processes, the agave sugar is unique because of the complex process to obtain it directly from syrup of natural Blue-Agave plants.

In addition to sweetness, the dry agave sweetener produced according to the methods of the present invention, provides flavor enhancement, synergy with other sweeteners and starches, improved shelf stability in acidic beverages and intermediate moisture foods, humectancy, surface browning, fermentable sugars for yeast-raised baked goods, and protection of delicate fruit textures in frozen foods.

Lyophilization, used to dry the agave nectar, avoids denaturation caused by heating the product, by maintaining it in a frozen state throughout the drying process.

Agave crystals, powder, solids and other dry forms produced by the method disclosed herein retain the naturally occurring minerals such as iron, calcium, potassium and magnesium. Its sugar composition is 90-95% oligofructose and 5-10% glucose; however the fructose is in its natural form (unlike high fructose corn syrup). The delicate processing ensures retention of the natural plant enzymes from agave and natural flavoring ingredients present in agave nectar.

The invention provides agave sweetener in dry form prepared according to the methods of the invention. The dry agave may be crystals, powder, granular, amorphous or a mixture thereof.

The average size of particles measured immediately after lyophilization or as soon as practical thereafter is preferably no more than 10, no more than 25, or no more than 100 μm. In some embodiments, the average particle size is 1-10, 1-15, 10-100 or 1-40 μm. In some embodiments, the average particle size is greater than 10 μm and up to 100 μm. In some embodiments, the average particle size is 0.1-100 μm.

In a particular aspect of the invention, the solid agave sweetener is provided in a kit or package which further comprises a drying agent or dessicant in a separate packaging made of a porous material that allows moisture to penetrate the package (such as a sachet made of paper). In some embodiments, the drying agent is silicon dioxide. In some embodiments, the sachets contain 2, 5, 7 or 10 g of the drying agent.

The dry agave sweetener of the invention is useful as a dietary supplement or replacement sweetener for people suffering from or susceptible to metabolic syndrome, insulin resistance, type II diabetes, abdominal weight gain and obesity, abnormal blood lipid profile (raised triglycerides and cholesterol) and high blood pressure.

### EXAMPLES

Without intent to limit the scope of the invention, exemplary instruments, apparatus, methods and their related results according to the embodiments of the present invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### Example 1

### Preparation of Agave Nectar from Raw Agave

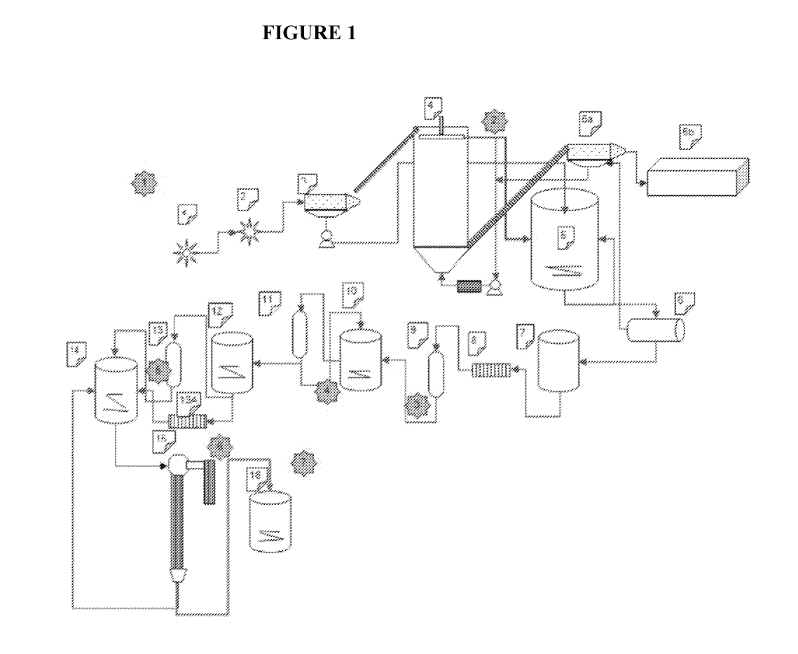

The steps illustrated in the schematic shown in FIG. 1, describe the industrial scale production of agave nectar from raw agave root bulbs. The various stages of the process are described in terms of the equipment used at a particular stage of the process.

TABLE 1

| No. | Process equipment description | Capacity | Parameters |
|---|---|---|---|
| 1 | Raw Agave Ripper | 7,000 | Kg/Hr |
| 2 | Hammer mill | 7,000 | Kg/Hr |
| 3 | Expeller | 1,500 | Kg/Hr |
| 4 | Ripped agave digestor | 20,000 | Liter |
| 5 | Juice Sterilization tank | 12,000 | Liter |
| 5a | Expeller to exhaust ripped agave | 1,500 | Kg/Hr |
| 5b | Hopper for agave bagasse | 3,000 | Liter |
| 6 | Rotary sifter to filter heavy solids | 1,500 | L/hr |
| 7 | Tank for prefiltered juice | 12,000 | Liter |
| 8 | duplex type filter press | 5 | gpm |
| 9 | Active carbon filters | 5 | gpm |
| | (I micron filtration) | | |
| 10 | Enzymatic reactors or Hydrolysis | 12,000 | Liter |
| 11 | Ultra filtration System | 6 | gpm |
| 12 | Unfolded juice tank | 12,000 | Liter |
| 13 | Nanofiltration System | 6 | gpm |
| 13a | stainless steel filter press to clarify | 6 | gpm |
| | juices | | |
| 14 | Evaporator feeding tanks | 12,000 | Liter |
| 15 | Evaporator | 1,200 | Kg/hr water |
| 16 | Agave Nectar Storage tanks | 12,000 | Liter |

### Example 2

### Crystallization of Agave Nectar by Lyophilization

The process of crystallization of the agave nectar involves changes in temperature, pressure and moisture throughout time, and optionally inoculating with maltodextrin, dextrose or any other hygroscopic compound to a lyophilizer.

During lyophilization, the syrup is entered into the chamber in large plates, where a hygroscopic compound (such as maltodextrin, dextrose or any solid sugar from sugarcane, sugar beets or sweet potato) is inoculated in order to provide a first crystal to which syrup crystals will attach.

Inside the chamber, temperature is lowered to −50° C. and pressure dropped to 10 microns.

After that, crystals start forming due to the sublimation of the water in the syrup, going from ice to vapor instantly and leaving the crystals on the plates.

From there, the hygroscopic compound stabilizes the crystals and prevents them from reabsorbing humidity as the temperature rises above 0° C. and the pressure is reinstated.

All publications and patent applications cited in this specification are incorporated herein by reference as if each individual publication or patent application were specifically and individually indicated to be incorporated by reference.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

What is claimed is:

1. An agave sweetener in dry crystal or powder form, wherein the dry agave sweetener retains essentially all of the perishable biological materials and minerals contained in nectar obtained from an agave plant, and wherein the dry agave sweetener remains stable when stored in a closed container.

2. The dry agave sweetener of claim 1, further wherein the dry agave sweetener is prepared from agave nectar by a process comprising lyophilization.

3. The dry agave sweetener of claim 1, wherein the sweetener is crystalline, amorphous, powder, granular or a mixture thereof.

4. The dry agave sweetener of claim 1, wherein the sweetener has an average particle size of 0.1 μm to 100 μm.

5. The dry agave sweetener of claim 1, wherein the sweetener further comprises a hygroscopic compound.

6. The dry agave sweetener of claim 5, wherein the hygroscopic compound is selected from maltodextrin, dextrose, glycolic acid, dried corn syrup, Stevia®, sugar from sugarcane, sweet potato or beet, or a mixture thereof.

7. The dry agave sweetener of claim 1, wherein the sweetener has equivalent sweetness about 120-200% compared to that of table sugar.

8. The dry agave sweetener of claim 1, wherein the sweetener is never heated above 50° C. at any time of production from harvest of raw agave.

9. The dry agave sweetener of claim 1, wherein the sweetener is stable for at least six months when stored in a closed container.

10. The dry agave sweetener of claim 1, wherein the agave plant is selected from Agave tequilana, Agave salmeana, Agave Americana, Agave maguey and Agave mapisaga.

11. A kit comprising:
the dry agave sweetener of claim 1; and
a drying agent provided in package made of porous material that allows moisture through the material.

12. The kit of claim 10, wherein the drying agent is silicon dioxide, silica gel, or diatomaceous earth.

13. A method for producing an agave sweetener in dry form, the method comprising:
a) introducing an agave nectar syrup in a lyophilization device;
b) reducing the temperature to below 0° C. and pressure to below atmospheric in the device; and
c) allowing a time period sufficient for sublimation of water contained in the agave nectar until one or more crystals of dry agave sweetener is formed.

14. The method of claim 13, further comprising:
inoculating the agave nectar syrup with a hygroscopic compound.

15. The method of claim 14, wherein the hygroscopic compound is selected from maltodextrin, dextrose or a mixture thereof.

16. The method of claim 13, wherein the temperature is reduced to −50° C.

17. The method of claim 13, wherein the pressure is reduced to 10 microns.

18. The method of claim 13, wherein the dry agave sweetener is crystalline, amorphous, powder, granular or a mixture thereof.

19. The method of claim 13, wherein the dry agave sweetener has an average particle size of 0.1 μm to 100 μm.

20. The method of claim 13, wherein the dry agave sweetener has equivalent sweetness about 120-200% compared to that of table sugar.

21. The method of claim 13, wherein the agave plant is selected from Agave tequilana, Agave salmeana, Agave Americana, Agave maguey and Agave mapisaga.

22. A method for providing a sweetener replacement in the diet of an individual, the method comprising: providing a compound according to claim 1, wherein the individual is suffering from or susceptible to metabolic syndrome, insulin resistance, type II diabetes, abdominal weight gain and obesity, abnormal blood lipid profile (raised triglycerides and cholesterol) and high blood pressure.
